(19) United States
(12) Patent Application Publication
(10) Pub. No.: US 2019/0363526 A1
(43) Pub. Date: Nov. 28, 2019

(54) CABLE HEATING APPARATUS AND METHOD

(71) Applicant: 674540 NB INC., Miramichi (CA)

(72) Inventor: Josh Derek Guimond, Bay Du Vin (CA)

(73) Assignee: 674540 NB INC., Miramichi, NB (CA)

(21) Appl. No.: 16/466,847

(22) PCT Filed: Dec. 6, 2017
(86) PCT No.: PCT/CA2017/051477

§ 371 Date: Jun. 5, 2019

Related U.S. Application Data
(60) Provisional application No. 62/431,097, filed on Dec. 7, 2016.

(51) Int. Cl. H02G 1/14; H05B 3/56

(52) U.S. Cl. CPC H02G 1/14; H05B 3/56

(57) ABSTRACT

A cable heating apparatus includes an insulated housing, and a heating element secured within the housing, the heating element configured to heat a cable termination. The apparatus also includes a cavity in the housing configured to receive the cable termination, the cavity defined by an inner surface configured to be heated by the heating element and having a tapered shape along a longitudinal axis of the cable termination. The apparatus further includes an actuator positioned on the housing and configured to control the heating element to heat the cable termination.

### TECHNICAL FIELD

This invention relates in general to cabling and, more specifically, to apparatuses and devices for heating cable terminations.

### BACKGROUND

Cables are utilized for a variety of applications, such as telecommunications, electric power supply, electrical wiring and sensing. Cables are often spliced to allow cable terminations to be interconnected at connection points and coupled to various components, devices and systems. Splicing and connecting cable terminations can be difficult in cold weather conditions, as the outer layer and insulator material in a cable can become brittle and difficult to remove, and also can make connecting the cable more difficult.

### SUMMARY

An embodiment of a cable heating apparatus includes an insulated housing, and a heating element secured within the housing, the heating element configured to heat a cable termination. The apparatus also includes a cavity in the housing configured to receive the cable termination, the cavity defined by an inner surface configured to be heated by the heating element and having a tapered shape along a longitudinal axis of the cable termination. The apparatus further includes an actuator positioned on the housing and configured to control the heating element to heat the cable termination.

An embodiment of a method of heating a cable termination includes inserting a cable termination in a cavity of an insulated housing of a cable heating apparatus, the cable heating apparatus including a heating element secured within the housing, and an actuator positioned on the housing and configured to control the heating element, the cavity defined by an inner surface having a tapered shape along a longitudinal axis of the cable termination. The method also includes controlling the heating element via the actuator to heat the inner surface and thereby heat the cable termination, and removing the cable termination from the cavity when the cable termination is at a selected temperature.

### BRIEF DESCRIPTION OF THE DRAWINGS

FIG. 1 is an exploded view of an embodiment of a cable heating apparatus in accordance with the present invention;

FIG. 2 is an exploded view of an embodiment of a cable heating apparatus in accordance with the present invention;

FIG. 3 is a side cutaway view of a cable termination inserted within a cavity of an embodiment of a cable heating apparatus in accordance with the present invention;

FIG. 4A is a perspective view of a cable heating apparatus according to an embodiment of the present invention;

FIG. 4B is a front view of an opening of the cable heating apparatus of FIG. 4A;

FIG. 4C is a semi-disassembled perspective view of the cable heating apparatus of FIG. 4A, showing a heating element having a tapered bore shape.

FIG. 5A is a side cutaway view of a cable termination inserted within a heating element of an embodiment of a cable heating apparatus in accordance with the present invention, showing aspects of heat distribution in the cable termination based on the heating element having a temperature of about 100° C.;

FIG. 5B is a side cutaway view of a cable termination inserted within the heating element of FIG. 5A, showing aspects of heat distribution based on the heating element having a temperature of about 130° C.;

FIG. 5C is a side cutaway view of a cable termination inserted within the heating element of FIG. 5A, showing aspects of heat distribution based on the heating element having a temperature of about 175° C.;

FIG. 6A is a side cutaway view of an embodiment of a cable heating apparatus in accordance with the present invention, which includes a clamping mechanism in an open position;

FIG. 6B is a side cutaway view of the cable heating apparatus of FIG. 6A, which includes the clamping mechanism in a closed position;

FIG. 7A is a side cutaway view of a cable heating apparatus in accordance with the present invention, which includes a clamping mechanism in an open position;

FIG. 7B is a side cutaway view of the cable heating apparatus of FIG. 7A, which includes the clamping mechanism in a closed position;

FIG. 8A is a side cutaway view of a cable heating apparatus in accordance with the present invention, which includes a biasing member in an open position;

FIG. 8B is a side cutaway view of the cable heating apparatus of FIG. 8A, which includes the biasing member in a closed position;

FIG. 9A is a side cutaway view of a cable heating apparatus in accordance with the present invention, which includes a biasing member in an open position;

FIG. 9B is a side cutaway view of the cable heating apparatus of FIG. 9A, which includes the biasing member in a closed position;

FIG. 10 is a side cutaway view of an embodiment of a cable heating apparatus in accordance with the present invention, which includes two opposed cavities;

FIG. 11 is a side cutaway view of an embodiment of a cable heating apparatus in accordance with the present invention, which includes two parallel cavities;

FIG. 12 is a side cutaway view of an embodiment of a cable heating apparatus in accordance with the present invention, which includes a cavity having multiple sizes.

The Figures are not to scale and some features may be exaggerated or minimized to show details of particular elements while related elements may have been eliminated to prevent obscuring novel aspects. Therefore, specific structural and functional details disclosed herein are not to be interpreted as limiting but merely as a basis for the claims and as a representative basis for teaching one skilled in the art to variously employ the present invention.

### DETAILED DESCRIPTION

Described herein are apparatuses, methods and systems for heating cables, facilitating splicing of cables and/or facilitating cable connections. An embodiment of a cable heating apparatus includes a heating element configured to at least partially surround an end of a cable (e.g., a cable termination). In one embodiment, the heating element includes one or more components that form a cylindrical or tapered heating surface. The heating surface may be a continuous surface or include multiple constituent surfaces configured to be arranged circumferentially around a cable termination when the cable end is inserted into the cable heating apparatus. In one embodiment, the cable heating apparatus is a hand-held apparatus.

In one embodiment, the cable heating apparatus includes an insulated housing configured to house a heating element. The heating element forms and/or at least partially surrounds a tapered or conical cavity into which a cable termination can be inserted. Upon insertion into the cavity, an inner surface defining the cavity contacts the cable termination at one or more locations and/or deforms at least part of the cable termination to increase the contact area between the surface and the cable termination. For example, the heating element forms or is operably connected to a conical cavity having inner dimensions selected so that there are multiple points of contact between the cable termination and the surface. The apparatus can be configured so that an external axial force (e.g., applied by a user when inserting the cable termination) causes the cable to be held in place by the conical cavity. In one embodiment, the apparatus includes a clamping mechanism that secures the cable termination in the cavity.

The heating element may take a variety of forms and have a variety of configurations. For example, the heating element can be a wrap heater that forms a continuous heating component, or have a plurality of individual heating components. Accordingly, the term “element” is not meant to limit the heating element to a single component, a specific number of individual components, or to any other specific configuration. Furthermore, the heating element can be configured to directly contact the cable termination, or can be configured to heat an intermediate component that forms a heating surface.

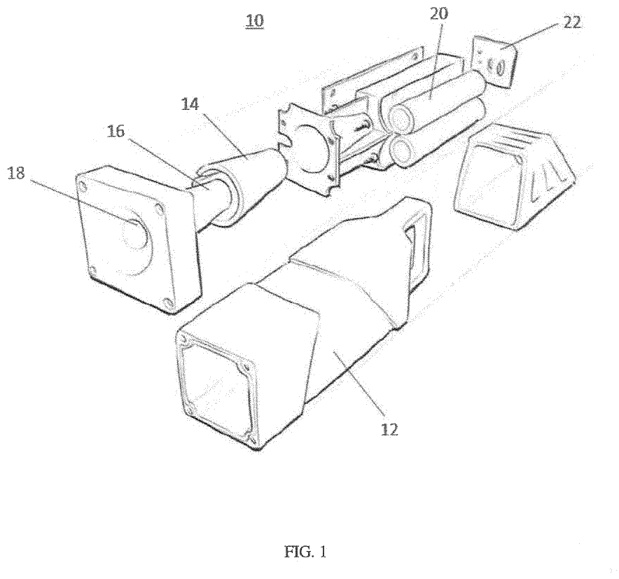

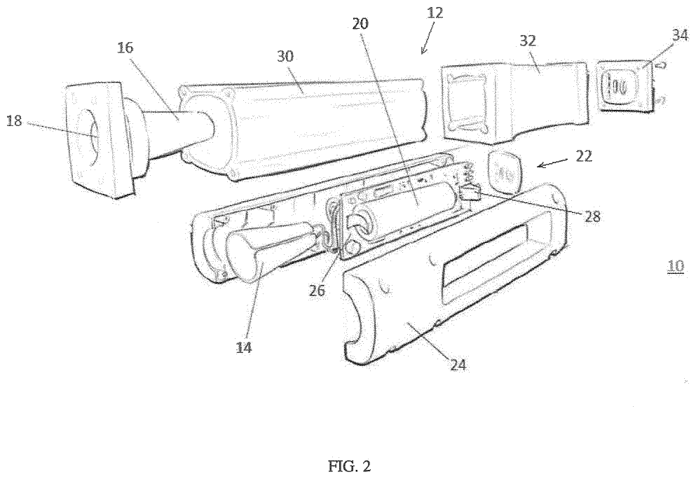

FIGS. 1 and 2 illustrate embodiments of a cable heating apparatus 10, which includes a housing 12 and a heating element 14 disposed therein. The housing 12 may be insulated in order to prevent at least an outer shell of the housing 12 to overheat. In one embodiment, the cable heating apparatus 10 is configured as a hand-held device or tool.

The apparatus 10 also includes a cavity into which a cable termination (not shown) can be inserted, which is defined by an inner surface. The inner surface may be a single continuous surface or multiple individual surfaces. In one embodiment, the inner surface defines a tapered shape along a longitudinal axis of the apparatus 10 and the cable termination. The apparatus 10 may include a receiving component 16 having an opening 18 constructed and arranged to receive the cable termination. The receiving component 16 in the apparatus 10 forms a conical cavity having a first end at or near the opening 18. The first end has a first diameter, and the cavity tapers to a second end having a smaller second diameter. The first and second diameters may be of any suitable size, and may be configured so that the tapered inner surface of the cavity contacts one or more points or areas on the cable termination.

The heating element 14 is shown in FIGS. 1 and 2 as a wrap heater, but can be any suitable heating device. Examples of the heating element 14 include a coil heater, a cartridge heater, or other similar heating means as known in the art.

The apparatus 10, in one embodiment, includes a power source 20 electrically connected to the heating element 14 to provide the required power to the heating element 14. The power source 20 may include one or more batteries, such as one or more alkaline batteries or lithium batteries. The apparatus may also include an actuator assembly 22 operatively engaged to the power source 20 to control the amount of heat applied to the cable termination.

FIG. 2 shows one example of a configuration of the apparatus 10, where the housing 12 includes an inner shell 24 in which the heating element 14 and the power source 20 are disposed. In this example, the power source 20 is mounted on a printed circuit board (PCB) 26 including suitable electronics and an actuator button 28.

In this example, the housing 12 includes an inner sleeve 30 that may be made from an insulating material, and an outer sleeve 32 made from silicon, rubber, plastic or another material. Assembly of the apparatus 10 includes securing halves of the inner shell 24 via screws, an adhesive or other mechanism, inserting the receiving component 16 into the heating element 14, inserting the inner shell 24 into the inner sleeve 30, and inserting the inner sleeve 30 into the outer sleeve 32. An actuator cover 34 may also be attached to an end of the outer sleeve and operably coupled to at least the actuator button 28.

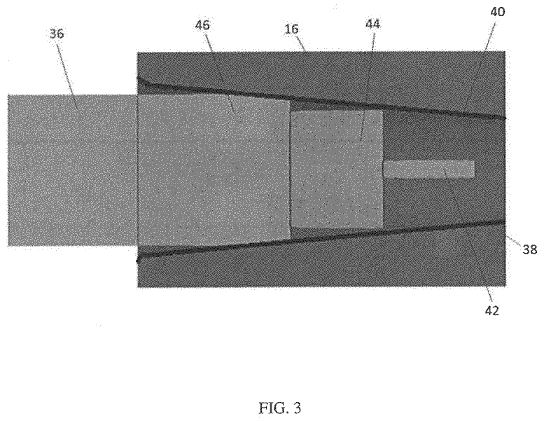

FIG. 3 shows aspects of the functionality of an embodiment of the apparatus 10 in heating a cable termination. An end or termination of a cable 36 is inserted into a conical or funnel-shaped cavity having a tapering wall or inner surface 38 that is heated to a selected temperature for heating the cable 36. The tapering inner surface 38 of FIG. 3 may be defined by the receiving component 16, but could be defined directly by the heating element 14 or other component configured to transfer heat from the heating element 14 to the termination of the cable. For example, the tapering surface 38 may be an inner surface of a wrap heater. A thermally conductive material 40 such as an aluminum film may be attached to the surface 38 to facilitate heat transfer to the cable termination.

The cable 36 includes a core 42, an inner insulating layer such as a dielectric layer 44, and an outer protective layer such as a cable jacket 46. The cable termination is formed by stripping the layer 44 and the jacket 46 to expose a portion of the core 42, and stripping the jacket 46 to expose a portion of the layer 44. The length of the exposed core portion and the exposed insulating layer portion may be selected to have a variety of lengths. For example, the layers may be stripped to form ¼″ lengths.

The tapering inner surface 38 is configured to contact the cable termination at one or more contact points or areas. As described herein, a contact point refers to a location or area of the surface 38 that is in contact with the cable termination. In one embodiment, the inner surface 38 is tapered or otherwise configured so that there are multiple points of contact. For example, two points of contact are shown in FIG. 3. A first point of contact is between the inner surface 38 and the jacket 46, and a second point of contact is between the inner surface 38 and the dielectric layer 44. Although not shown, the taper can be configured so that a third point of contact is established between the surface 38 and the core 42 when the cable termination is inserted into the apparatus 10.

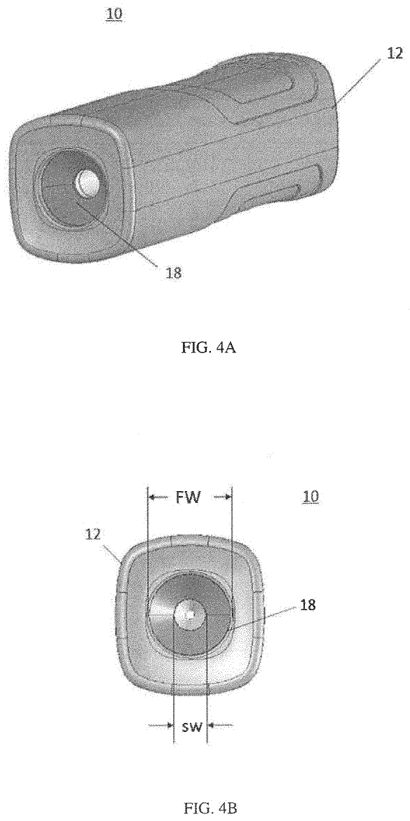

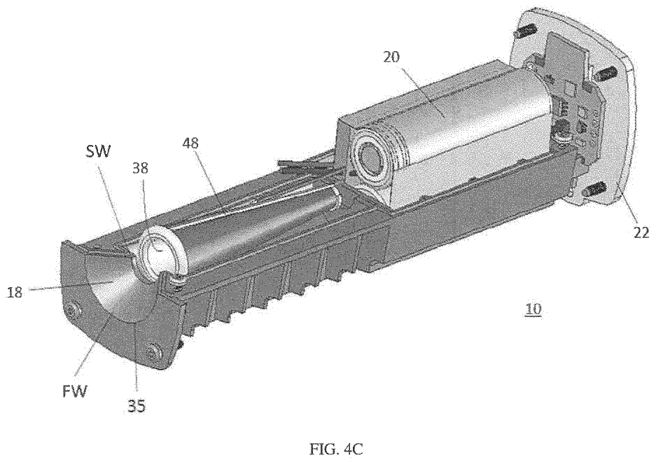

FIGS. 4A-4C show an example of the apparatus 10, in which the cavity and the surface 38 are defined by an inner surface of the heating element 14. In this example, the heating element 14 is or includes a wrap heater that is electrically coupled to a power source 20 such as a battery.

With reference to FIG. 4A, the housing 12 is generally rectangular and shaped to be handled with ease by a technician, although the housing may have any suitable shape, such as a cylinder or a rectangular body with ergonomic features. The opening 18 allows for insertion of a cable for heating, and may have a shape and/or size configured to accept specific cables or selected ranges of cable sizes. In this example, the opening 18 has an inner cone shape defining a larger diameter toward the exterior of the housing 12 and a smaller diameter toward the interior of the housing 12. In other words, the opening 18 has an area (orthogonal to the longitudinal axis of the apparatus 10) that is relatively large at the outer edge of the housing 12, and narrows as the cone shape approaches the heating element 14.

As shown in FIGS. 4A-4C, the opening 18 has a first width or diameter denoted as “FW,” and has a second width or diameter denoted as “SW.” The first and second widths FW and SW define the inner cone shape of the opening 18. The opening 18 can have various widths or diameters for FW and SW, allowing for various cables to be used with the apparatus 10. For example, the width range for FW can be from 1 inches to 10 inches, and the width range for SW can be from ¼ inches to 5 inches. The width of the cable which can be inserted into the apparatus 10 is dependent on the widths of FW and SW. In another example, the cavity has a length of about 8 inches, a FW width of about 30 mm (about 1.2 inches) and a SW width from about zero to about 12 mm (about 0.5 inches).

With reference to FIG. 4C, a semi-disassembled view of this example of the cable heating apparatus 10 is shown. The opening 18 has a conical shape defined by a greater width FW at the exterior and a smaller width SW at or near the heating element 14. Because FW and SW are selected based on the types of cables to be used, the opening 18 ensures that the cable termination is centrally positioned within the heating element 14.

The heating element 14 in this example includes a wrap heater 48 that has a tapered bored shape, with the largest area of the tapered shape located at or near the width SW. The tapered cavity defined by 48 the heating element 14 has a size and shape configured to maintain the termination centrally within the cavity and to allow the termination to extend axially to a selected location. The size and shape of the tapered cavity also causes one or more points of contact when the cable termination is inserted. In one embodiment, an axial force used to insert the cable termination causes a section of a cable jacket and/or other layer to deform and take on the tapered shape, which can both improve heat transfer to the cable termination and secure the cable termination in the heating element 14.

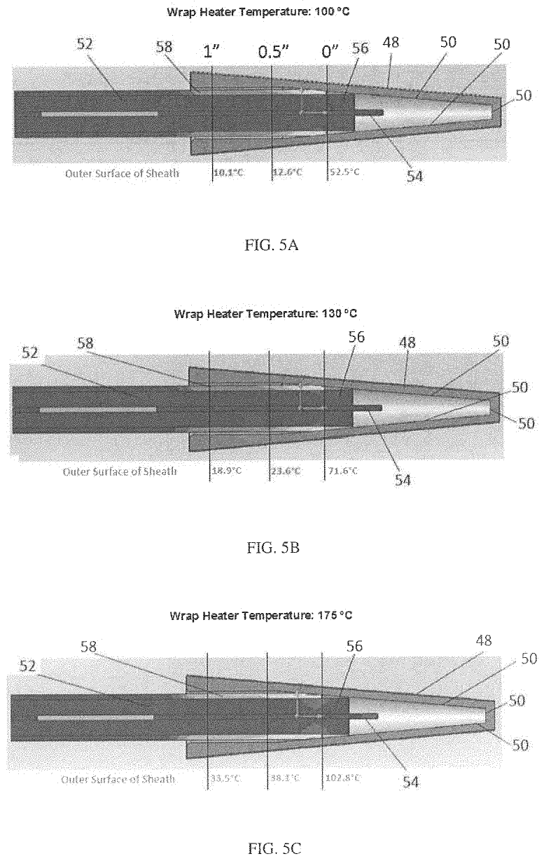

FIGS. 5A-5C show a cable termination as inserted into the wrap heater 48, which defines a cavity having an inner surface 50. In this example, the cable termination is formed from a cable 52 having a core 54, a dielectric layer 56 and a jacket 58. The cable 52 has been stripped so that the termination has an exposed core portion, an exposed dielectric portion, and a jacketed portion disposed within the cavity. Due to the funnel shape provided by the tapering inner surface 50 of the cavity, the wrap heater 48 is able to accommodate various cable sizes. Bigger cables 50 will abut the tapering inner walls of the cavity at an earlier point relative to the opening 18, and the wrap heater 48 will still provide an effective amount of heat to the cable 52.

As shown, the tapered shape of the cavity results in multiple points or areas of contact. A first point of contact is formed between the jacket and the inner surface, and a second point of contact is between the dielectric layer and the inner surface. Although the tapered shape in this example is selected so that the exposed core portion does not contact the inner surface, the taper can be designed having an angle that allows the exposed core portion to be inserted and placed in contact with the inner surface. For example, the wrap heater 48 may taper to approximately zero or taper to an end having a selected width.

The taper can be configured (e.g., have an angle) so that a cable having a defined thickness can be inserted and allowed to extend to a selected point and define one or more points or areas of contact. In one embodiment, the taper has an angle that is between 0.1 degrees to 45 degrees. For example, the angle may be 5 degrees. In another embodiment, the range is between about 1 degree and about 10 degrees.

As shown in FIGS. 5A-5C, the tapered shape can also cause part of the jacket 58, the dielectric layer 56, and/or any other layer to be deformed into a conical or funnel shape, which can increase the amount of heat transfer to the layer and thereby more effectively and more quickly heat the cable termination. FIG. 5A shows the wrap heater 48 having a temperature of about 100° C. Near the opening of the wrap heater 48, the temperature of the jacket 58 is about 10.1° C., and increases to 12.6° C. further into the cavity. At a location or region at which the jacket is deformed, the highest heat transfer occurs, causing the jacket 58 to be heated to about 52.5° C.

FIG. 5B shows the wrap heater 48 having a temperature of about 130° C., resulting in a jacket temperature of about 18.9° C. near the opening, a higher jacket temperature of about 23.6° C. further into the cavity, and a jacket temperature of about 71.6° C. where deformation of the jacket 58 occurs. FIG. 5C shows the wrap heater 48 having a temperature of about 175° C., resulting in a jacket temperature of about 33.5° C. near the opening, a temperature of about 38.1° C. further into the cavity, and a jacket temperature of about 102.8° C. where deformation of the jacket 58 occurs. These examples show how the tapered shape can improve heating amounts and efficiencies relative to other configurations.

The wrap heater 48, the receiving component 16 or other heating element and/or cavity may be configured to heat a cable termination to any suitable temperature. For example, for some types of cables, the cable termination is heated to a temperature up to about 200° F. (about 93° C.), such as a temperature between about 150° F.-200° F. (about 65° C.-93° C.) or 180° F.-200° F. (about 82° C.-93° C.). In one example, the cable termination is heated to a temperature between about 185° F. (85° C.) and about 195° F. (91° C.).

In some instances, the actual temperature in the cavity can fluctuate around the temperature at which the cavity is heated. For example, at cavity temperatures in the 180-200° F. range, the temperature can fluctuate by as much as 7° F. or 10° F. For example, at 190° F., the actual temperature can fluctuate between, e.g., 187° F. and 194° F. or 185° F. and 195° F. In such instances, the temperature selected for the cavity may be set lower than the desired temperature to account for such fluctuations, e.g., by reducing the set temperature by about 2% relative to the desired temperature.

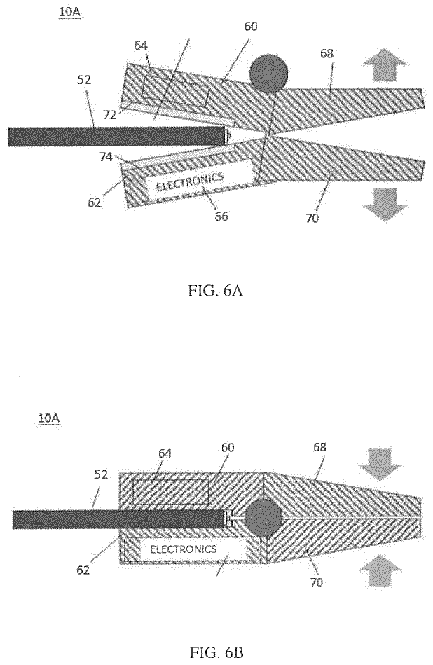

FIGS. 6A-6B, 7A-7B, 8A-8B, and 9A-9B show embodiments of a cable heating apparatus of the present invention, which include one or more clamping or securing components or mechanisms. FIGS. 6A and 6B show an example of a cable heating apparatus 10A including opposing jaw sections 60 and 62. A heating element 64 is incorporated into or in thermal communication with the jaw section 60 and/or the jaw section 62. Electronics 66 for controlling the heating element 14 may be disposed in a recess or cavity in one or more of the jaw sections for controlling the heating element 64. In this example, a spring mechanism exerts a spring force to hold the apparatus 10A in an open position (FIG. 6A), which can be overcome by squeezing handles 68 and 70 to close the jaws. FIG. 6B shows a closed position, in which inner surfaces 72 and 74 are in contact with or proximate to the cable termination. The heating element 64 can be operated via, e.g., a button or other actuator, or by closing the jaws.

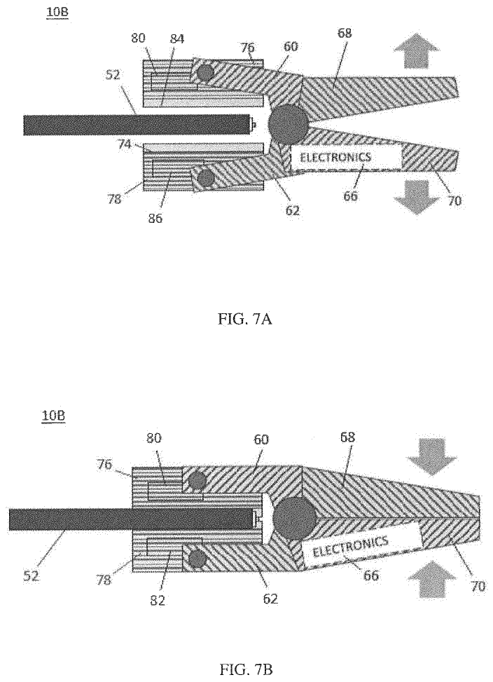

FIGS. 7A and 7B show an example of a cable heating apparatus 10B in an open position and in a closed position, respectively. In this embodiment, the jaws 60 and 62 are connected via pivot points to clamping components 76 and 78 that incorporate respective heating elements 80 and 82. The apparatus can be closed by squeezing handles 68 and 70, to cause inner surfaces 84 and 86 of the clamping components 76 and 78 to contact or be proximate to the cable termination.

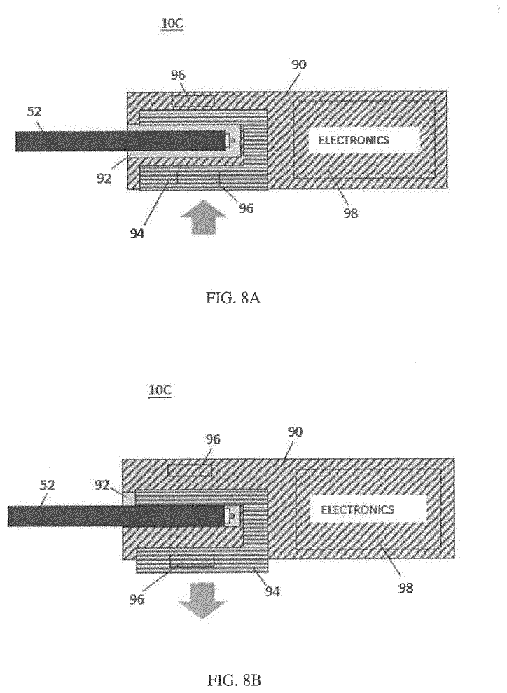

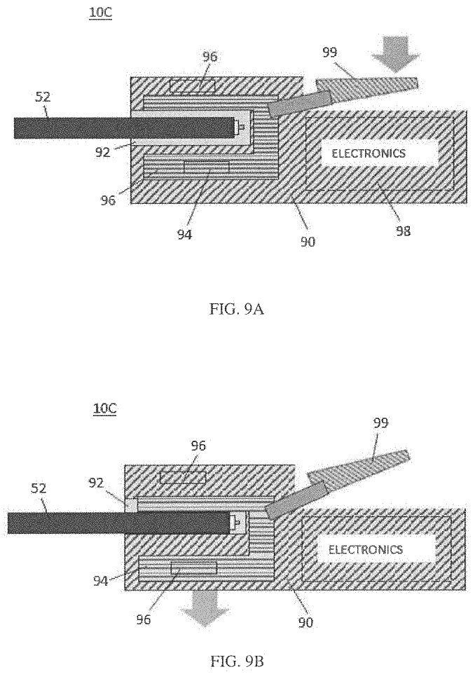

FIGS. 8A-8B and 9A-9B show examples of a cable heating apparatus 10C including a biasing device or member. In these examples, the apparatus 10C includes a housing 90 defining an internal cavity 92 into which the termination of a cable 52 may be inserted. The apparatus 10C also includes a biasing member 94 to close the cavity 92 and clamp a cable termination in place. In the example of FIGS. 8A-8B, the biasing member 94 is biased by a spring mechanism to hold the apparatus 10C open, as shown in FIG. 8A. Squeezing or pushing on the biasing member 94 causes the apparatus 10C be in a closed position as shown in FIG. 8B. One or more heating elements 96 can be incorporated into or in thermal communication with the housing 90 and/or the biasing member 94, and electrically connected to electronics 98.

FIGS. 9A and 9B show a similar example of the apparatus 10C in an open and closed position, respectively. In this example, the biasing member is operated by a handle or clamp 99, which can be pressed in order to open the apparatus 10C and release the cable 52.

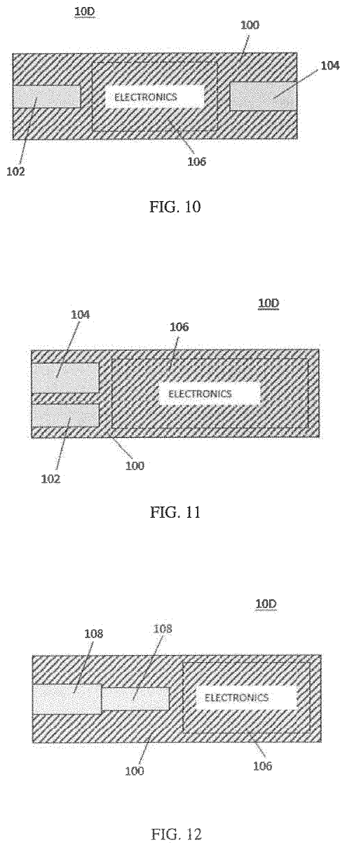

FIGS. 10-12 show embodiments of a cable heating apparatus 10D of the present invention, in which the apparatus 10 has a body 100 that includes multiple cavities 102 and 104. Electronics 106 are electrically connected to one or more heating elements configured to heat inner surfaces of the cavities. The cavities may be sized so as to have generally the same size as a cable, or configured to have a tapered or conical shape, so that no biasing member is required.

FIG. 10 shows an embodiment where the cavities 102 and 104 are at opposing ends of the body 100. FIG. 11 shows an embodiment where the cavities 102 and 104 are at the same end and are generally parallel to each other. In FIG. 12, a single modified cavity 108 is provided which has two shapes to accommodate multiple cable sizes. For example, the cavities may be designed to accommodate common sizes of coaxial cables, such as the sizes for RJ6 and RJ11 cables.

The cavities are shown in FIGS. 6A-6B, 7A-7B, 8A-8B, 9A-9B and 10-12 as cylindrical cavities, however the embodiments are not so limited. For example, the cavities can have a tapered or conical shape similar to, e.g., the receiving component 16, the heating element 14 and/or the wrap heater 48.

The cable heating apparatus 10 may be used in a method of heating a cable termination. The method includes multiple steps, which may be performed in the order described below but may be performed in a different order. Further, the method may include all of the steps described, or include fewer than all of the steps.

In a first step, a cable termination is inserted into a cavity having an inner surface that is formed by or in thermal communication with a heating element. Insertion may include inserting the cable axially into a tapered cavity, a cylindrical cavity or any other suitably shaped cavity. The first step may also include actuating a biasing or clamping mechanism. In a second step, the heating element is actuated, e.g., by pushing an actuator button or engaging a clamping or biasing mechanism. In a third step, the cable termination is retained within the cavity until the cable is sufficiently heated. For example, the cable termination is retained until the cable termination reaches a desired temperature or a selected amount of time has passed. The cable termination may be heated to a temperature that is high enough to allow the cable termination to be connected to a connector or other component, while being low enough to avoid harming or damaging the cable termination or cable.

In a fourth step, the cable termination is removed from the cavity. The method may then be repeated as desired until, e.g., the cable termination is ready for engaging with a connector or other component.

In an alternative embodiment, the method includes heating the cable termination until a desired temperature is reached, and retaining the cable termination within the cavity and at the desired temperature for a selected amount of time. The cable may then be removed, or the temperature is lowered to a stable state for a certain amount of time before removal, which can help to decrease subsequent heating times. For example, as the interior of the cavity can take a significant amount of time to completely cool (e.g., to room temperature), the cavity may be allowed to cool for a shorter period of time until the cavity is not completely cool but is at a lower temperature (e.g., about 100° F. or 38° C.).

The cable heating apparatus can be used to heat telecommunication cables, but is not so limited. For example, the heating apparatus could be modified to heat any wire, tube, hose or other product used to interconnect two points or which requires an adapter/connector to be positioned at one end of a wire, tube, hose or conduit.

Embodiments described herein present a number of improvements and advantages relative to prior art configurations. The cable heating apparatus provides a relatively simple mechanism that can effectively heat a cable termination at the surfaces and also heat the cable termination radially through all layers of the termination. The cable heating apparatus described herein also addresses challenges in industries that utilize cables, which can arise when cable terminations become too cold. When a cable termination becomes too cold, the cable termination may be prevented from being properly coupled with a connector or other component. For example, under conditions that result in the temperature of a cable termination to get too low, cable coverings can become brittle, which can cause difficulty in attaching and crimping a cable termination with a connector. Such challenges exist with coaxial cables; however, other types of cables exhibit similar drawbacks. The embodiments described herein address the above challenges.

The embodiments provide additional advantages in facilitating cable connections, as heating a cable termination can be advantageous regardless of temperature. For example, some types of cable, such as flooded cable, are much easier to install in a connector when heat is added.

Although embodiments are described herein in conjunction with hand-held cable termination heating devices, they are not so limited and can be used in any suitable device or system that may utilize heating means for cables. For example, the heating element described above may be incorporated into a cable connector or any other suitable device or component that can be coupled to a cable termination.

The terms “first,” “second,” and the like, herein do not denote any order, quantity, or importance, but rather are used to distinguish one element from another. In addition, the terms “a” and “an” herein do not denote a limitation of quantity, but rather denote the presence of at least one of the referenced item.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the foregoing description.

1-20. (canceled)

21. A cable heating apparatus comprising:
an insulated housing;
a heating element secured within the housing, the heating element configured to heat a cable termination;
a cavity in the housing configured to receive the cable termination, the cavity defined by an inner surface configured to be heated by the heating element and having a tapered shape along a longitudinal axis of the cable termination; and
an actuator positioned on the housing and configured to control the heating element to heat the cable termination.

22. The apparatus of claim 21, wherein the tapered shape extends axially from a first end coupled to an exterior of the housing to a second end within the housing, the first end having an area that is greater than an area of the second end.

23. The apparatus of claim 22, wherein the tapered shape is a conical shape.

24. The apparatus of claim 21, wherein cable termination includes a cable core and one or more layers surrounding the cable core, and the cavity is configured to contact at least one of the one or more layers when the cable termination is inserted into the apparatus.

25. The apparatus of claim 24, wherein the cavity is configured to deform at least one of the one or more layers when the cable termination is inserted into the apparatus.

26. The apparatus of claim 24, wherein the cavity is configured to contact the cable termination at a plurality of points of contact between the inner surface and at least one of the one or more layers when the cable termination is inserted into the apparatus.

27. The apparatus of claim 24, wherein the one or more layers includes an inner layer and a jacket surrounding the inner layer, and the plurality of points of contact include a first point of contact between the inner surface and the inner layer, and a second point of contact between the inner surface and the jacket.

28. The apparatus of claim 21, wherein the cavity and the inner surface are formed by a surface of the heating element.

29. The apparatus of claim 21, wherein the insulated housing forms part of a hand-held tool.

30. The apparatus of claim 21, further comprising a power source electrically connected to the heating element to provide energy to the heating element.

31. The apparatus of claim 29, wherein the actuator is configured to be actuated to provide power to the heating element from the power source.

32. The apparatus of claim 21, further comprising a biasing member configured to secure the cable termination within the cavity.

33. The apparatus of claim 21, further comprising a clamping mechanism operatively connected to the cavity.

34. A method of heating a cable termination, comprising:
inserting a cable termination in a cavity of an insulated housing of a cable heating apparatus, the cable heating apparatus including a heating element secured within the housing, and an actuator positioned on the housing and configured to control the heating element, the cavity defined by an inner surface having a tapered shape along a longitudinal axis of the cable termination;
controlling the heating element via the actuator to heat the inner surface and thereby heat the cable termination; and
removing the cable termination from the cavity when the cable termination is at a selected temperature.

35. The method of claim 34, wherein the tapered shape extends axially from a first end coupled to an exterior of the housing to a second end within the housing, the first end having an area that is greater than an area of the second end.

36. The method of claim 35, wherein the tapered shape is a conical shape.

37. The method of claim 34, wherein cable termination includes a cable core and one or more layers surrounding the cable core, and inserting the cable termination includes contacting at least one of the one or more layers with the inner surface.

38. The method of claim 37, wherein inserting the cable termination includes applying an axial force to the cable termination and deforming at least one of the one or more layers by the inner surface.

39. The method of claim 37, inserting the cable termination includes contacting the cable termination at a plurality of points of contact between the inner surface and at least one of the one or more layers.

40. The method of claim 34, wherein the cable heating apparatus is a hand-held tool.
